(19) United States
(12) Patent Application Publication
(10) Pub. No.: US 2020/0198741 A1
(43) Pub. Date: Jun. 25, 2020

(54) SEMI-SUBMERSIBLE FLOAT, IN PARTICULAR FOR A WIND TURBINE

(71) Applicant: NAVAL ENERGIES, Paris (FR)

(72) Inventors: Thomas CHAPALAIN, Paris (FR); Cyrille MOIRET, Lanester (FR); Joël GRIGNOUX, Guipavas (FR)

(21) Appl. No.: 16/608,784

(22) PCT Filed: Apr. 26, 2018
(86) PCT No.: PCT/EP2018/060737

§ 371 Date: Oct. 25, 2019

(30) Foreign Application Priority Data
Apr. 27, 2017 (FR) 17 53697

(51) Int. Cl. B63B 35/44; F03D 13/25; B63B 43/06

(52) U.S. Cl. CPC B63B 35/44; B63B 2035/446; B63B 43/06; F03D 13/25

(57) ABSTRACT

The invention relates to a semisubmersible float, in particular for an offshore wind turbine, comprising at least four columns, including a central column and three outer columns connected to the central column by arms in the form of a pontoon, the outer columns and the pontoon arms comprising ballasts, is characterized in that the ballasts are filled by gravity and emptied using compressed air.

### CROSS-REFERENCE TO RELATED APPLICATIONS

This application is the U.S. National Phase under 35 U.S.C. § 371 of International Application PCT/EP2018/060737, filed Apr. 26, 2018, which claims priority to FR Application No. 17 53697, filed Apr. 27, 2017, the entire contents of each of which are incorporated by reference herein and made a part of this specification.

### FIELD OF THE INVENTION

The present invention relates to a float, in particular for an offshore wind turbine.

For example, the invention can relate to semisubmersible floats made from steel or concrete, or from steel and concrete, also called hybrid floats.

### BACKGROUND OF THE INVENTION

Such hybrid floats are already known in the state of the art, for example from document WO 2014/031009.

This document describes such a float that includes at least four columns, including a central column and three outer columns, connected to the central column by arms in pontoon form.

In this document, the outer columns are connected to the central column in a star configuration.

The outer columns and the pontoon-forming arms of this float then also include ballasts, making it possible to adjust the buoyancy level of this float.

This for example makes it possible to transport and install this wind turbine on an electricity production site.

Floats of this so-called hybrid nature use a mixed structure for example made from steel for the columns and for example from concrete for the pontoon-forming branches, between them.

In the aforementioned prior document, means for emptying these ballasts by pumping are also provided.

These pumping means in fact make it possible to pump water outside these ballasts to modify the buoyancy of the assembly.

This prior document therefore generally describes the concept of a semisubmersible float for a wind turbine.

### SUMMARY OF THE INVENTION

The present invention aims to advance the definition of this type of float.

To that end, the invention relates to a semisubmersible float, in particular for an offshore wind turbine, comprising at least four columns, including a central column and three outer columns connected to the central column by arms in the form of a pontoon, the outer columns and the pontoon arms comprising ballasts, characterized in that the ballasts are filled by gravity and emptied using compressed air.

According to other features of the float according to the invention, considered alone or in combination:
the ballasts of the arms comprise a portion extending in the central column;
the compressed air for emptying is supplied by a compressed air source carried by a support vessel and associated with embranchment means on connection means for connecting to the ballasts;
the compressed air source comprises means forming an air compressor;
the embranchment means include connecting pipes extending in the central column between the portion of the ballasts extending in the central column and connection means for connecting to the compressed air source, which are provided in the upper part of this central column;
the ballasts comprise a portion that rises in the outer columns;
the columns have a cylindrical cross-section;
the pontoon arms have a rectangular cross-section;
the pontoon arms comprise partitions delimiting compartments in the corresponding ballast portions;
the columns are made from steel and the arms from concrete and in that the columns are connected to the arms by fastening flanges associated with post-stress members embedded in the concrete of the pontoon arms.

### BRIEF DESCRIPTION OF THE DRAWINGS

The invention will be better understood upon reading the following description, provided solely as an example, and done in reference to the appended drawings, in which:

FIG. 1 shows a perspective view of an exemplary embodiment of a to submersible float of an offshore wind turbine according to the invention,

FIG. 2 shows a schematic side view illustrating ballasts of such a float,

FIG. 3 shows a partial cutaway view of such a float and illustrating these ballasts,

FIG. 4 shows a schematic view illustrating means for emptying such ballasts, and

FIG. 5 illustrates the connection between outer columns and pontoon arms of such a float.

### DETAILED DESCRIPTION OF THE INVENTION

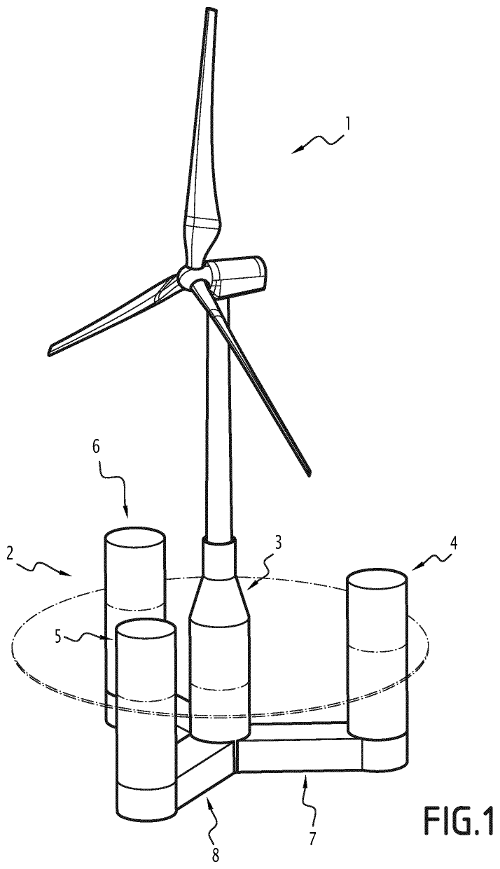

FIG. 1 indeed illustrates a semisubmersible float in particular for an offshore wind turbine.

This offshore wind turbine is designated by general reference 1 in this FIG. 1, and the float thereof is designated by general reference 2.

In the present application, a hybrid float has been illustrated, that is to say, a float using two different materials to produce the parts thereof.

Thus and as has been described in the prior document previously mentioned, such a float includes at least four columns for example made from steel or concrete, including a central column designated by general reference 3 and three outer columns designated by general references 4, 5 and 6.

These outer columns 4, 5 and 6 are connected to the central column 3, by arms in the form of a pontoon (or pontoon arms) made from steel or concrete, two of which, for example 7 and 8, are illustrated in this FIG. 1.

As also previously indicated, the central and outer columns can be steel or concrete columns and have a cylindrical cross-section, while the pontoon arms can be made from steel or concrete and have a rectangular cross-section.

In this float, the outer columns and the pontoon arms include ballasts.

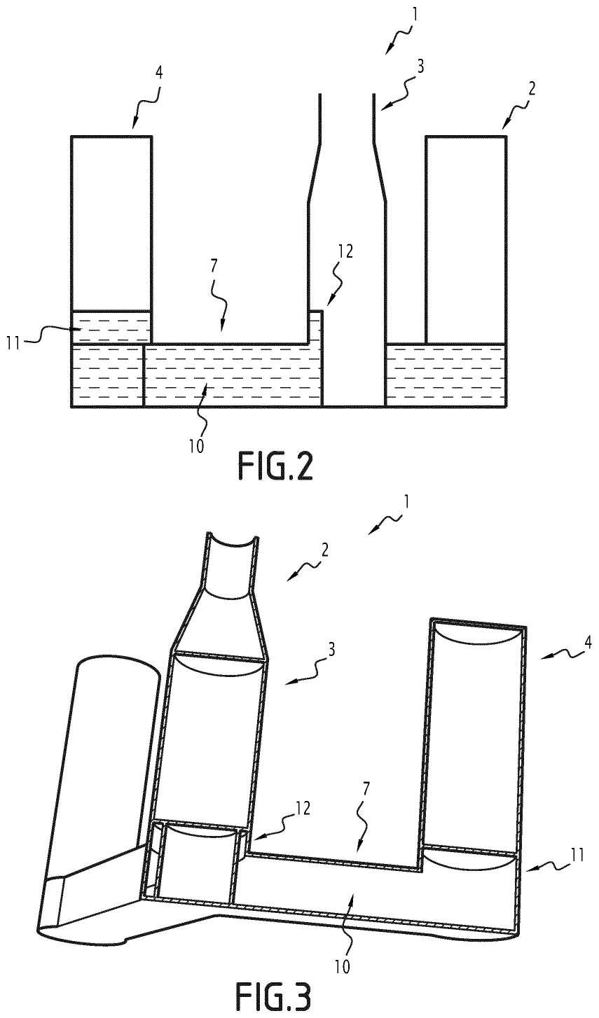

Such ballasts are for example illustrated in FIGS. 2, 3 and 4.

Indeed, these figures show the central column 3, an outer column for example 4, and the pontoon arm connecting this outer column to the central column, for example the arm 7.

As illustrated, the outer columns and the pontoon arms include ballasts such as the ballast designated by general reference 10 in these FIGS. 2 to 4.

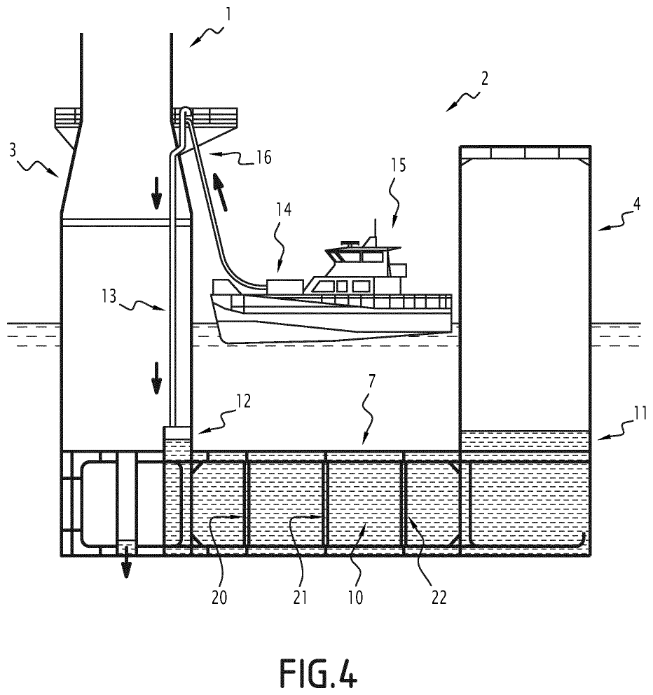

By one of their ends, these ballasts extend at outer columns of the float and for example include, as illustrated more clearly in FIG. 4, a portion that rises in the corresponding outer column 4, for example the ballast portion designated by general reference 11 in this FIG. 4.

At the other of their ends, these ballasts for example include a portion that extends in the central column 3, this portion being designated by general reference 12 in these figures for the ballast 10.

As also appears in these figures, the columns can have a cylindrical cross-section, while the pontoon arms can have a rectangular cross-section.

More specifically and as illustrated in FIG. 4 in particular, this central column 3 of the float also comprises join means for connecting ballasts to a compressed air source for emptying.

Thus, in the described float, the ballasts are filled by gravity and emptied by compressed air.

These figures, and in particular FIG. 4, show join means designated by general reference 13 in this figure, for connecting the ballast portion, for example 12, extending in the central column, to a compressed air source for emptying these ballasts.

This compressed air source is designated by general reference 14 in this FIG. 4.

Indeed, this compressed air source can for example include means forming an air compressor, for example carried by a support vessel or the like, designated by general reference 15 in this FIG. 4, and associated with embranchment means designated by general reference 16, for connecting this source on the means 13 for connecting to the ballast.

One can in fact see that in such a float, the ballasts are connected to compressed air pipes or channels for emptying, to which it is possible to connect a compressor to ensure the emptying thereof.

Such quick connection means of the conventional type are then provided for example in the upper part of the central column, to allow a connection of the source to the ballasts.

The compressor can then be pooled between several wind turbines for example on an electricity production site.

A support vessel or the like can then be used to move these means between different wind turbines, for example of a farm, in order to reduce the installation and operating costs thereof.

Indeed, quick connection means of the conventional type can be used in order to connect the compressor carried by the vessel to the compressed air channels for emptying the ballasts.

These ballasts are then filled by gravity and emptied by compressed air, as previously mentioned.

FIG. 4 also illustrates the fact that the ballasts for example comprise delimiting partitions therein that may or may not be sealed, constituting divider compartments of these ballasts.

For example, the ballast designated by general reference 10 in FIG. 4 comprises three intermediate partitions, respectively 20, 21 and 22, making it possible to define different compartments in the latter.

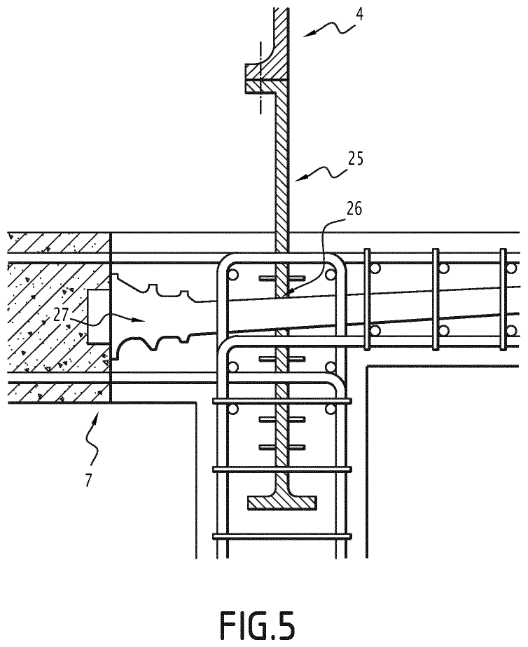

FIG. 5 illustrates an example of connection means between a pontoon arm, for example 7, and an outer column, for example 4.

This connection can for example be made by a flange designated by general reference 25, on which the steel column 4 is fastened in one manner or another, for example by welding or screwing.

This flange includes holes, for example 26, for the passage of post-stress members 27, a portion of which is embedded in the concrete of the pontoon arms 7, for example.

This then makes it possible to ensure the fastening of the flange, which can be made from steel, on the pontoon arms, and the fastening of the column on this arm, for example by welding.

Of course, still other embodiments can be considered.

1. A semisubmersible float, for an offshore wind turbine, comprising at least four columns, including a central column and three outer columns connected to the central column by arms in the form of a pontoon, the outer columns and the arms in the form of a pontoon comprising ballasts, wherein the ballasts are ballasts to be filled by gravity and to be emptied by compress air.

2. The semisubmersible float, for an offshore wind turbine, according to claim 1, wherein the ballasts of the arms in the form of a pontoon comprise a portion extending in the central column.

3. The semisubmersible float, for an offshore wind turbine, according to claim 1, wherein the compressed air for emptying is supplied by a compressed air source carried by a support vessel and associated with embranchment means on join means for connecting to the ballasts.

4. The semisubmersible float, for an offshore wind turbine, according to claim 3, wherein the compressed air source comprises means forming an air compressor.

5. The semisubmersible float, for an offshore wind turbine, according to claim 2, wherein the embranchment means include connecting pipes extending in the central column between the portion of the ballasts extending in the central column and connection means for connecting to the compressed air source, which are provided in the upper part of this central column.

6. The semisubmersible float, for an offshore wind turbine, according to claim 1, wherein the ballasts comprise a portion that rises in the outer columns.

7. The semisubmersible float, for an offshore wind turbine, according to claim 1, wherein the columns have a cylindrical cross-section.

8. The semisubmersible float, for an offshore wind turbine, according to claim 1, wherein the arms in the form of a pontoon have a rectangular cross-section.

9. The semisubmersible float, for an offshore wind turbine, according to claim 1, wherein the arms in the form of a pontoon comprise partitions delimiting compartments in the corresponding ballast portions.

10. The semisubmersible float, for an offshore wind turbine, according to claim 1, wherein the columns are made from steel and the arms in the form of a pontoon from concrete and in that the columns are connected to the arms by fastening flanges associated with post-stress members embedded in the concrete of the arms in the form of a pontoon.
